(19) United States
(12) Patent Application Publication
(10) Pub. No.: US 2014/0215474 A1
(43) Pub. Date: Jul. 31, 2014

(54) IMPLEMENTING A WORKFLOW ON DATA ITEMS

(71) Applicant: Hewlett-Packard Development Company, L.P., Houston, TX (US)

(72) Inventors: Mimi Chu Dong, Greeley, CO (US); Chao-Pei Chen, Ft. Collins, CO (US); Jeffrey Lee, Ft. Collins, CO (US); Troy Roberts, Loveland, CO (US)

(73) Assignee: Hewlett-Packard Development Company, L.P., Houston, TX (US)

(21) Appl. No.: 13/756,058

(22) Filed: Jan. 31, 2013

(51) Int. Cl. G06F 9/48

(52) U.S. Cl. CPC G06F 9/4881
USPC 718/102

(57) ABSTRACT

A workflow container is established that is associated with a profile, where the profile specifies a set of actions. A set of data items can be received in the workflow container, and multiple actions can be performed on the set of data items based on the profile. In implementing the workflow, one example provides or a first set of operations are performed for a given data item in parallel with a second set of operations. The first set of operations communicate the first data item to at least a first destination, and the second set of operations communicate the given data item to at least a second destination.

### BACKGROUND

There exist various mechanisms to facilitate people with task and workflow management. For example, users can manage lists and perform actions manually, implement rules with email programs, and synchronize files with online sources so as to share or have network access to their files.

### BRIEF DESCRIPTION OF THE DRAWINGS

FIG. 1 illustrates an example workflow system for establishing a workflow that can perform multiple actions for a user.

FIG. 2 illustrates an example method for implementing a workflow that performs multiple actions for a user.

FIG. 3 illustrates an example workflow, such as provided through a system of FIG. 1, or a method of FIG. 2.

FIG. 4A through FIG. 4D illustrate example interfaces for enabling a user to provide input in establishing a workflow.

FIG. 5 is a block diagram that illustrates a computer system upon which embodiments described herein may be implemented.

### DETAILED DESCRIPTION

Examples described herein include a workflow system in which a user is able to specify actions to be performed on data items based on a profile that the user creates. Among other features, the profile can specify for actions to be performed in parallel and/or in sequence for some or all data items. Additionally, the user can establish through the profile a schedule for when select actions are to be performed.

Examples described herein provide for a workflow to be implemented on data items. A workflow container is established that is associated with a profile. A set of data items can be received in the workflow container, and multiple actions can be performed on the set of data items based on the profile. In implementing the workflow, one example provides for a first set of actions to be performed for a given data item in parallel with a second set of actions on the same data item. The first set of actions communicate the first data item to at least a first destination, and the second set of actions communicate the given data item to at least a second destination.

In one example, a computer system includes a memory and one or more processors. The one or more processors use instructions from memory to establish a workflow container for a user. The workflow container may be associated with a profile, and the profile may include a set of actions that are specified by the user. The profile may also specify one or more schedules for performing one or more actions specified in the profile. A set of data items may be received in the workflow container. Multiple actions are performed from the set of actions on individual data items in the set of data items, and one or more of the actions are performed in accordance with the schedule specified in the profile.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many smart phones and tablets), and magnetic memory. Computers, terminals, network enabled devices (e.g. mobile devices such as cell phones) are all examples of machines and devices that utilize processors, memory, and instructions stored on computer-readable mediums. Additionally, embodiments may be implemented in the form of computer-programs, or a computer usable carrier medium capable of carrying such a program.

System Description

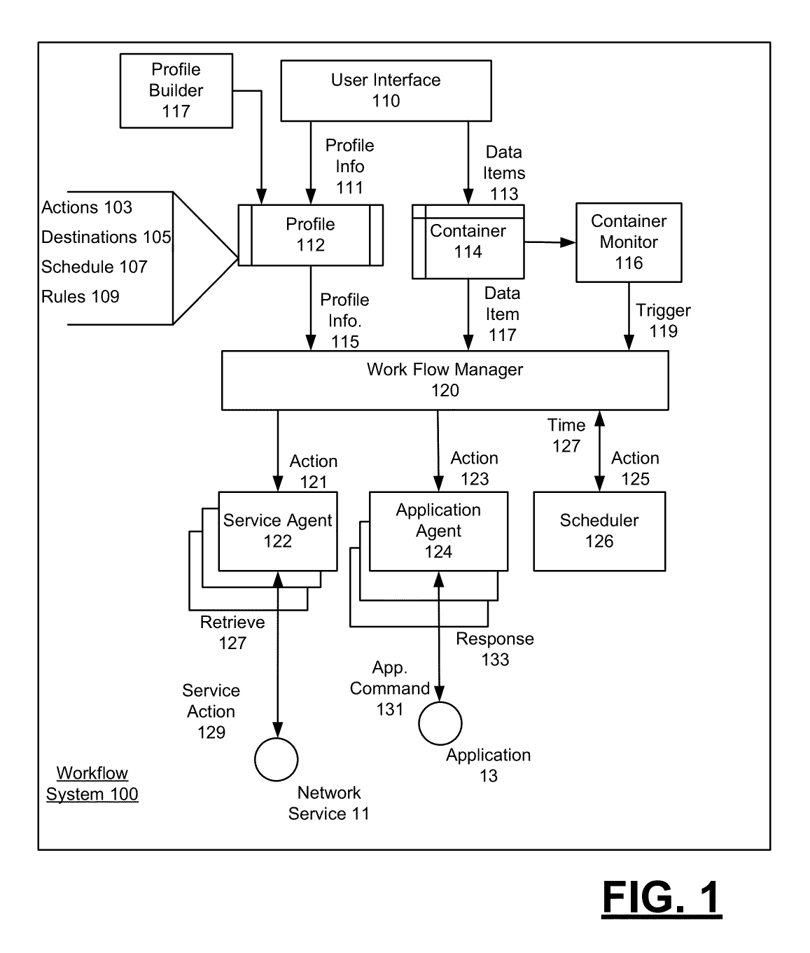

FIG. 1 illustrates an example workflow system for establishing a workflow that can perform multiple actions on data items on behalf of a user. In some examples, system 100 implemented as a client system on a user's computer, such as on a personal computer, laptop, tablet or mobile computing device. In such implementations, the system 100 may utilize network interface capabilities of the client system in order to communicate with various network services. In variations, system 100 can be implemented on, or as part of a service that communicates with end user devices on which the applications are in use. Still further, system 100 can be implemented as a hybrid system that includes both client functionality and network service operations, for purpose of enabling the establishment and use of a workflow container that resides on the user machine and cloud service. Other variations are also possible, including those in which the system 100 is implemented on a network of interconnected computers that communicate over peer to peer channels.

With reference to FIG. 1, system 100 includes a workflow manager 120 that employs one or more service agents 122, one or more application agents 124 and/or a scheduler 126. In performing operations, the workflow manager 120 can enable the creation and use of a user profile 112, which as described below, automates the performance of several user-specified actions. The workflow manager 120 can establish a container 114 which receives, or otherwise obtains, data items 117 of the user. A monitor 116 can correspond to functionality that signals a trigger 119 to the workflow manager 120, in response to the inclusion of a data item in the container 114.

In more detail, system 100 can include a user interface 110 that enables the user to manually or programmatically specify data items for the container 114. The container 114 can correspond to a folder, maintained on the user's client system, cloud service or both. The user interface 110 may also enable the user to specify rules or other logic which programmatically trigger identification and placement of data items 113 into the container 114. The rules of logic can be incorporated as part of system 100, or be native to another application or service available to the user. For example, the user can establish a mailbox rule that moves certain characteristics, such as messages that originate from a particular sender, to the workflow container 114.

The user interface 110 also includes functionality for enabling the user to establish profile 112. The profile 112 can identify (i) actions 103 that are to be programmatically and/or automatically performed, as well as (ii) destinations 105 where data items subject to the specified actions are communicated. As an alternative or addition, the profile 112 can include timing and event parameters, which designate rules to identify when specific actions 103 are to be performed, either in relation to other actions, or in relation to the time or designated event. Still further, the profile 112 can include scheduling information 107, which designates a time when certain actions 103 are to be performed for some or all data items in the workflow container 114. The profile 112 can also include rules 109 for handling of data items that are of specific types, such as handling of images versus documents versus e-mails. Thus, for example, the handling of an image in the workflow container 114 can include performance of actions (e.g., upload the social networking site) that are different than the handling of e-mails (e.g., which can be archived or forwarded etc.).

Numerous other types of parameters or rules can also be included with the profile 112. For example, the profile 112 can identify (i) login and password information for users network service accounts, (ii) devices in which workflow container 114 is to be made available (e.g., the user can specify the workflow container 114 to be available on his cell phone), and/or (iii) finance information for paying for services, etc.

In some implementations, the profile 112 can be developed in part through one or more intelligent profile builders 117. The profile builders 117 can operate as application layer logic that runs in the background to interface with various programmatic resources associated with the user, or on a computer on which system 100 is provided. For example, the profile builder 117 can interface with and monitor activity of the user with respect to other applications or network services (e.g., social media services of a user). The profile builder 117 can scan activity logs, records (e.g., emails) and other data sources to identify information such as favorite destinations of the user, favorite contacts, types of files the user frequently exchanges, certain programmatic tasks the user repeats, and times when such tasks are performed, or preferred to be performed.

According to some examples, the user interface 110 enables a user establish multiple containers 114. For example, the user interface 110 can be structured to enable the user to specify containers 114 based on destinations, based on a classification of the destination (e.g., ‘friends’ ‘family’ or ‘work’), based on data type (e.g., container for images versus container for e-mails) or various other configurations.

The container monitor 116 can correspond to a process that detects the placement of data items in the container 114. For example, monitor 116 can include functionality provided with the container 114 that causes the trigger 119 to be generated automatically, responsive to the inclusion of each data item 113 in the container 114. Alternatively, monitor 116 can correspond to a separate process that polls the container 114, to determine the contents of the container repeatedly, or alternatively, in response to certain conditions (e.g., such as the opening of a certain application that forms part of system 100).

According to examples, workflow manager 120 is able to perform numerous types of actions on individual data items 113 specified by the user. In particular, the workflow manager 120 can perform actions 103 designated from the profile 112. In one implementation, the workflow manager 120 performs one or more actions 103 to communicate a data item 113 to a specific destination 105 (e.g., upload to social network site, e-mail to specific person). If the action 103 that is to be performed specifies a network service as the destination 105 (e.g., online social networking site, online archiving or document synchronization etc.), workflow manager 120 may invoke a network service agent 122 for the particular network service 11. The invoked service agent 122 can perform interface operations, such as performing login and password submission, and/or establishing socket connection to communicate the data item 113 of the action 103 to the specified network service 11.

If the action that is to be performed specifies the use of an application (e.g., forward through e-mail program), the workflow manager 120 may invoke an application agent 124 (e.g., plug-in) to interface with the designated application 13. For example, the application 13 can be opened, and a workflow manager may perform the action 103 to communicate a particular data item 113 to a specific destination 105 (all of which are specified in profile 112) using the application agent 124. Various operations can be performed in order for the workflow manager 120 to complete an action requiring the use of an application 13. For example, application agent 124 can enter input on behalf of the user, including specifying text (e.g., interface with e-mail application by composing address and subject line), as well as application-specific actions (e.g., attach a file to an open e-mail). To further the example of an e-mail program, application agent 124 can open the e-mail program (if not already open), open a new un-composed e-mail, compose the e-mail by programmatically retrieving or generating text (e.g., include e-mail address specified by destination 105 for the action, and type text corresponding to subject line), perform an action such as including an attachment corresponding to the data item that is receiving the particular action) and send the e-mail with the attachment.

The workflow manager 120 can also include a scheduler 126. The scheduler 126 can read schedule information 107 from the user profile 112, and then pair the schedule information 107 to specific actions 103. The scheduler 126 can operate on a clock, or in response to events and timing parameters (first perform one action, then perform next action etc.). In this way, scheduler 126 operates to specify timing parameters 127 for individual actions 103 of the data items in the container 114.

In implementation, the workflow manager 120 and/or other components of the system 100 can be implemented as application layer logic that can run, for example, on a computing device. For example, workflow manager 120 and user interface 110 can be implemented as part of an application that interfaces with other applications and services. The system 100 can also be implemented for different computing environments. For example, in a mobile computing environment, the workflow manager 120 and/or other components of the system 100 can be run in a background process, to monitor for events that affect a designated container.

Methodology

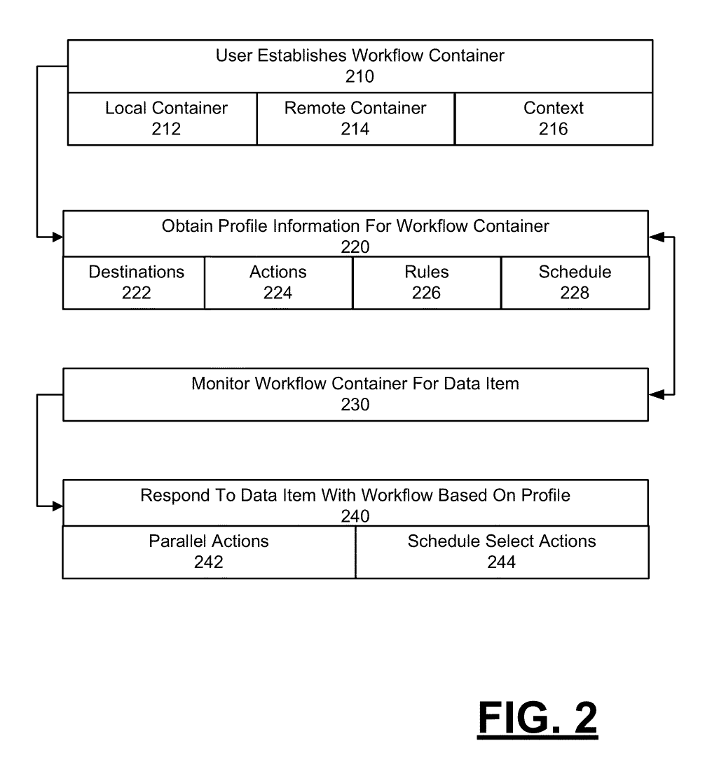

FIG. 2 illustrates an example method for implementing a workflow that performs multiple actions for a user. A method such as described by FIG. 2 can be implemented using components of a system such as described by FIG. 1. Accordingly, reference may be made to elements of system 100 in FIG. 1 for purpose of illustrating suitable components for performing a step or sub-step being described.

With reference to FIG. 2, a user establishes a workflow container (210). The workflow container can correspond to a folder, or combination of folders. In one implementation, the container can be local to the user's client system (e.g., folder on user's personal computer) (212). As an addition or variation, the workflow container can be part of a network service, such as one hosted by a cloud service (214). As another variation or addition, one or more containers can be established based on context (216). For example, a user may establish separate containers for work or personal use, and each container can be local, provided as part of a network service, or local and part of the network service.

Profile information may be obtained for the workflow container (220). If multiple workflow containers are in use, each workflow container can include a separate profile. The profile associated with each workflow container can specify (i) destinations where individual data items are to be communicated to (222), (ii) actions that are to be performed on individual data items, or with specific containers (224), (iii) rules that are to be implemented regarding, for example, events, conditions or other parameters as to how actions are to be performed (226), and/or (iv) a schedule regulating when individual actions are performed, or when series of actions are performed on a particular container (228).

Once the workflow containers and profiles are established, each workflow container is monitored to detect the inclusion of data items in the particular workflow container (230). Data items can be designated for workflow containers with user input, or alternatively, obtained programmatically (or automatically) through processes that identify and move data items into the respective workflow containers. For example, logic or rules can designate when data items from a particular source (e.g., user folder or directory, network service etc.) are retrieved and placed in a particular workflow container.

When data items are detected in a particular workflow container, the workflow manager 120 responds by performing actions as specified by the associated profile 112 (240). The actions can specify destinations were data items are to be communicated, including local destinations (e.g., folders or applications), as well as remote location, such as network services, online folders or addresses (e.g., e-mail addresses) of users or other devices.

In some examples, the workflow manager implements parallel actions on a given data item (242). As such, a single data item, or set of data items, can have multiple processes performed in parallel, where each process can include one or more actions. By way of example, a user can specify a set of images for a particular workflow folder. Individual images, or the set of images, can be communicated to a network service, such as a photo publishing service or social networking site. Concurrently, the photos can be communicated locally to a folder and/or application, such as an application that reformats the images are taxed them with metadata.

As an addition or alternative, actions can be scheduled for individual data items, a set of data items, or for the workflow container in general (244). In the case when multiple data items are placed in the container, a series of actions can be sequenced based on, for example, the user's profile. Furthermore, each action can be timed, based on a time (e.g., hour, day, week) or event (e.g., the completion of another action). For example, processes performed in parallel can include multiple actions, and the process as a whole, or individual actions specified by a given process, can be scheduled for a time (e.g., hour, day, week etc.) or condition.

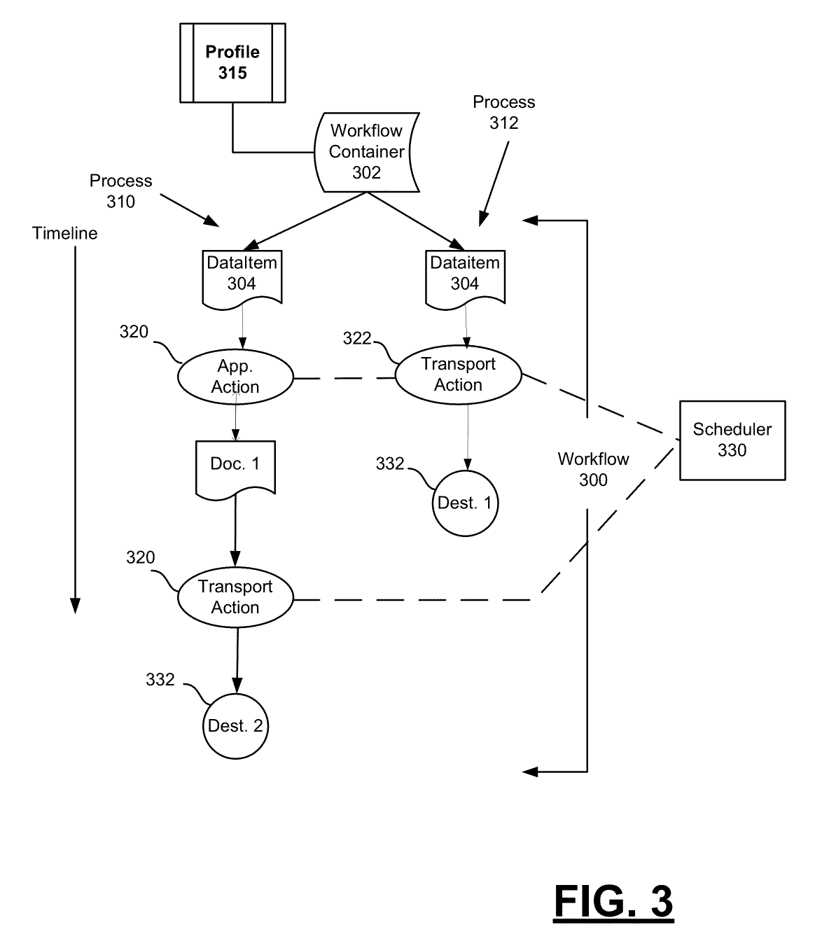

FIG. 3 illustrates an example workflow, such as provided through a system of FIG. 1, or a method of FIG. 2. In an example of FIG. 3, a workflow 300 is implemented for a workflow container 302. The workflow container 302 can reside locally, such as on the user's computer system, or remotely, such as with a cloud service. Among other benefits, the container 302 can be established as a single point of interface for the user to interact with multiple network services and/or applications.

The workflow 300 includes parallel processes 310, 312 each of which serve to perform a series of actions 320, 322 on a data item 304 that is provided in the container 302. Each process 310, 312 includes a series of actions 312. The workflow manager 120 can perform each action 320, 322 on a respective data item 304 of the workflow container 302, and result in the data item, or a processed version of the data item (e.g., reformatted), being communicated to a particular destination 332. In the example provided, the workflow manager 120 can implement the processes 310, 312, as well as the actions that comprise each process, based on specifications made in a profile 315 associated with the workflow container 302.

In the example of FIG. 3, the data item 304 is subjected to parallel processes 310, 312, each of which include one or more actions performed in series. For example, process 310 can include a first action 320 that communicates the data item to a local application (e.g., data editing or formatting), and the processed data item is then subjected to a second action 320 to transport the data item to a remote destination 322 (e.g., destination specified by URL or email address). The process 312 can be performed concurrently or independent of process 310 on the same data item. For example, the data item 304 can be subjected to a transport action (e.g., upload data to network service, send email with data item etc.).

In an alternative example, the data items 304 of each process 310, 312 can be different. In such an implementation, the user can configure the workflow with profile information that selects processes for data items. The particular process 310, 312 that is selected for each data item 304 can be based on a characteristic of the individual data items. Furthermore, the process 310 performed for one data item 304 can include additional actions as compared to the process 312 performed for another data item. As noted, the determination as to which of the processes 310 are performed on each data item can be based on characteristics of each data item. The characteristics can include, for example, a file type of each data item, or metadata associated with each data item. By way of example, if the data item 304 is a document, the first process 310 is performed, and if the data item 304 is an image, the second process is performed 312. The determination as to the process performed, as well as the individual actions and other information, can be specified in the profile 315 associated with the particular container 302.

The actions 320, 322 for each process 310, 312 can further be subjected to a schedule 330. In particular, the moment when each action 320, 322 is performed can be planned to correspond to a timing parameter (e.g., hour, day etc.) or event or condition. The schedule 330 can be set by input provided from the user using profile 315. The schedule 330 can be used to time individual actions with respect to a timeline, (i) within a process (e.g., perform actions in series at designated times), (ii) relative to other actions in the same process or different process, and/or (iii) responsive to events.

Example User Interfaces

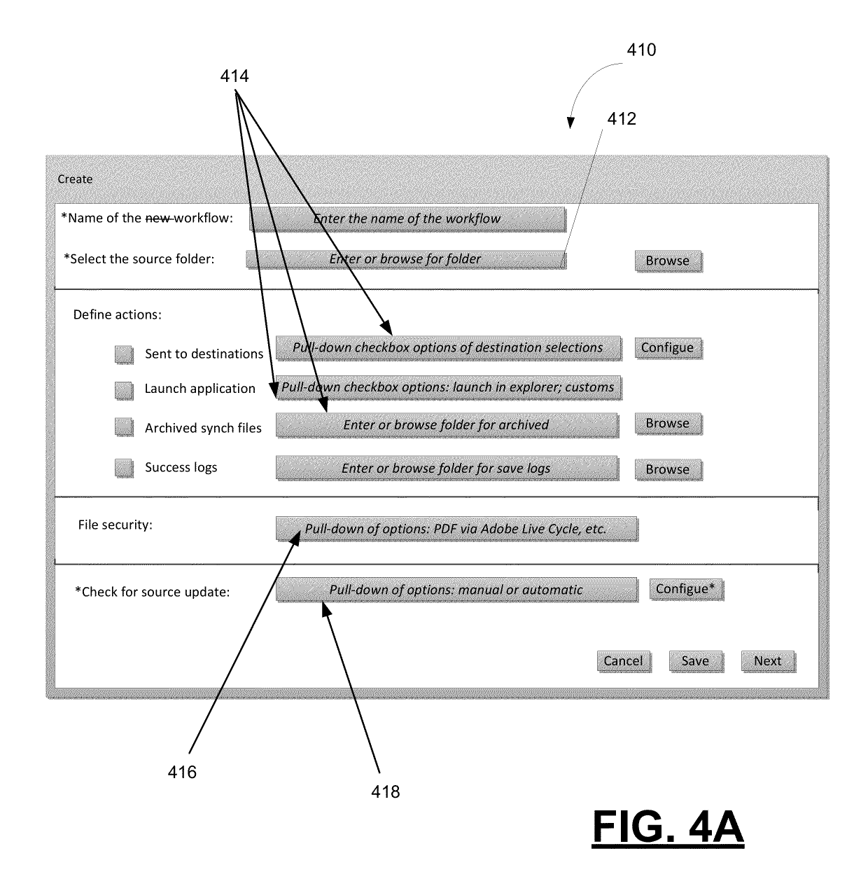

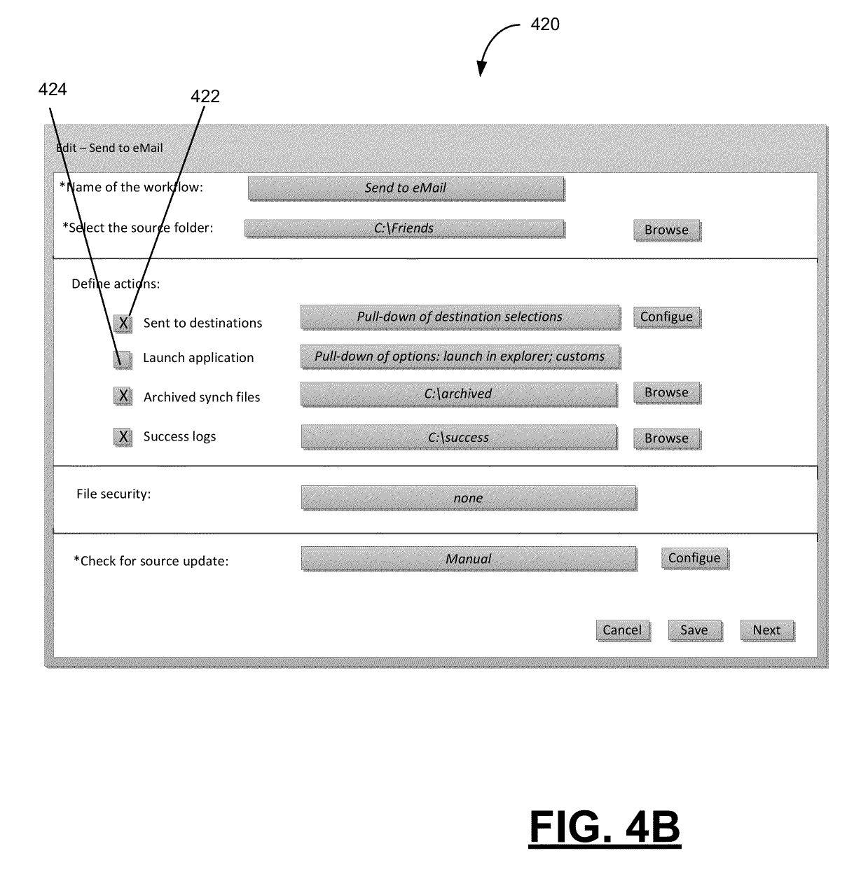

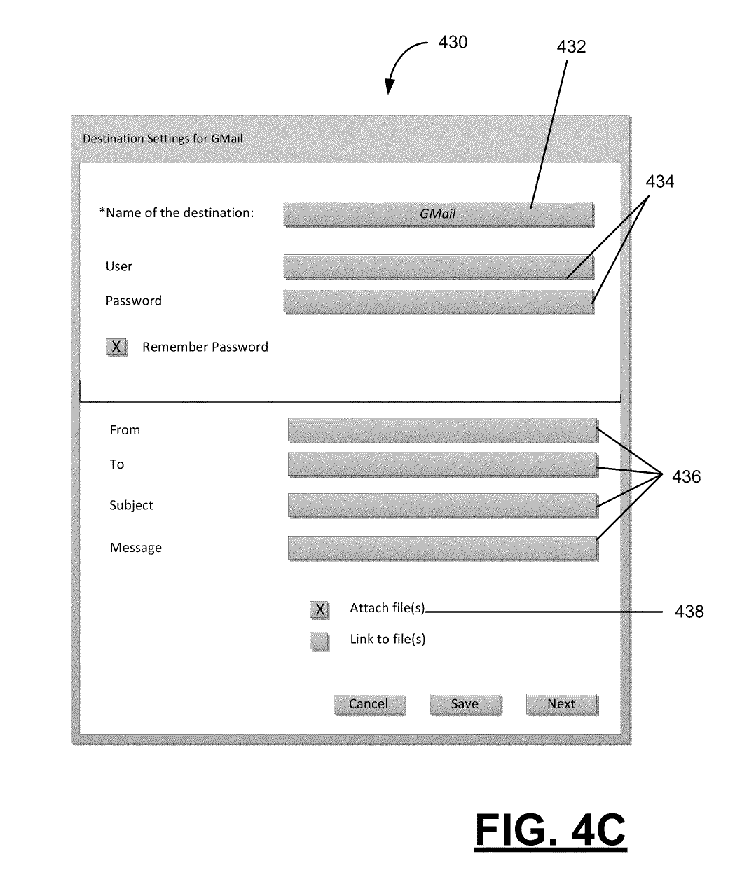

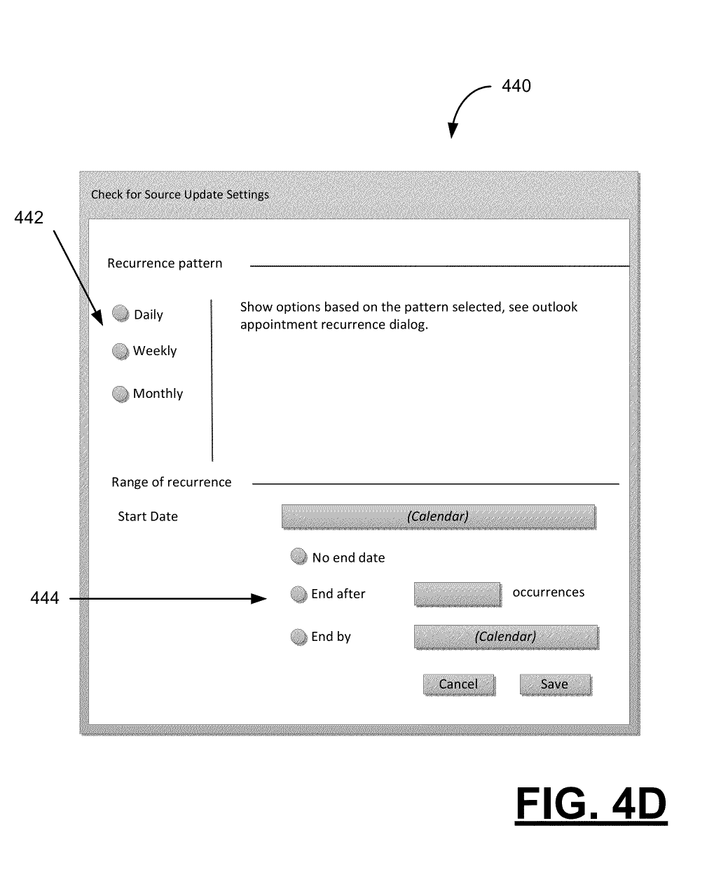

FIG. 4A through FIG. 4D illustrate example user interfaces for enabling a user to provide input in establishing a workflow. For example, with reference to FIG. 1, the user interface 110 can implement interfaces such as described by FIG. 4A through FIG. 4D in order to enable the user to establish one or more workflow containers. Information determined from the user input can be stored with a profile that is associated with the particular workflow container.

With reference to FIG. 4A, the interface 410 enables the user to create a workflow folder. In creating the workflow folder, the user can be provided a feature 412 for designating the folder that is to serve as the container for data items on which the workflow is to be acted upon. The folder designated by feature 412 can be local, or provided through a network service.

The interface 410 can also provide a second set of features 414 for enabling the user to specify one or more actions that are to performed on a given data item when it is placed in the identified folder. The actions can correspond to (i) sending the data item to a destination specified by feature, (ii) launching an application specified by feature, (iii) archiving or syncing. A third set of features 416 enables the user to designate the type of security or encryption to employ when performing one of the defined actions. A fourth feature 418 enables the user to designate how and when the folder of the workflow is to be checked for data items. For example, the user can designate manually action, where the user provides input to initiate a given workflow, or automatic response, where the workflow manager 120 (see FIG. 1) is automatically triggered to perform actions for the workflow.

FIG. 4B illustrates an example interface for a workflow, or portion thereof, in which a data item is emailed to a destination. In FIG. 4B, the user can use a first feature 422 to select destinations that include, or associated with email addresses. The user can also use a second feature 424 to specify a specific application for performing the action.

FIG. 4C illustrates an interface 430 for enabling the user to configure a specific action for the workflow. With interface 430, the user can use a first feature 432 to specify the destination as being an Internet email service. As part of the service, the interface 430 can include a second set of features 434 enable the user to specify username and password. A second set of features 436 can also enable the user to specify text or values for fields for generating the message through the Internet service. In particular, the third set of features 434 can enable the user to specify text and values for composing the email, such as from, to, subject and message fields. A fourth feature 436 enables the user to communicate the date item as an attachment, or alternatively, as part of the body of the email. Other features 438 can enable to user to specify links to files.

FIG. 4D illustrates an example interface 440 for setting the timing for when the container is to be checked for data items. A first set of features 442 enable the user to select times when the container monitor 116 (see FIG. 1) checks the container. Calendar features 444 can further enable the user to select times when the container is checked and the actions of the workflow are performed.

Hardware Diagram

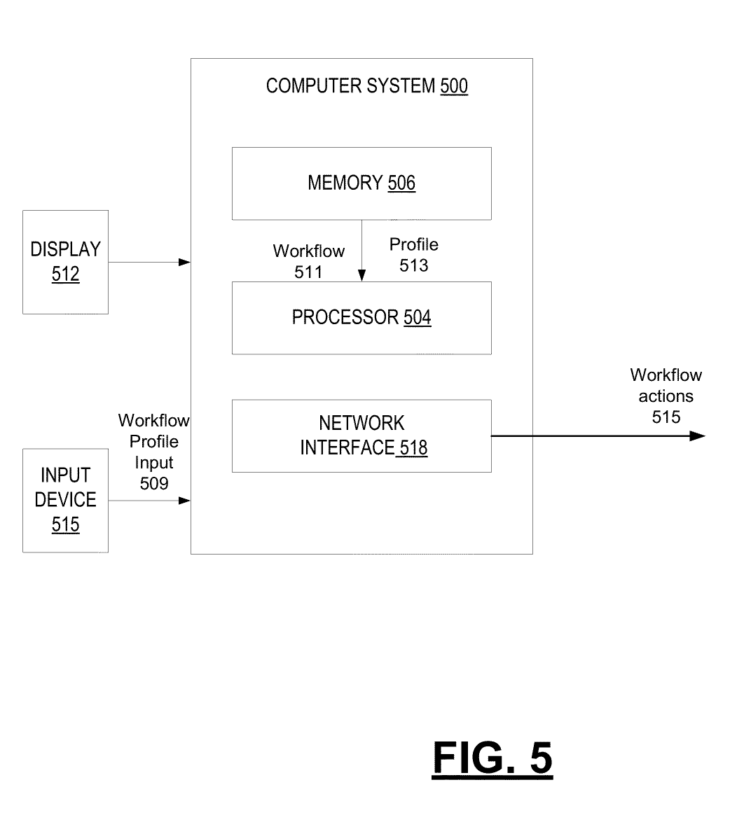

FIG. 5 is a block diagram that illustrates a computer system upon which embodiments described herein may be implemented. For example, in the context of FIG. 1, system 100 may be implemented using a computing system such as described by FIG. 5.

In an embodiment, computer system 500 includes processor 504, main memory 506 (including non-transitory memory), and network communication interface 518. Computer system 500 includes at least one processor 504 for processing information. Computer system 500 also includes a memory 506 for storing information and instructions to be executed by processor 504. The memory 506 can correspond to a combination of memories, including ROM, RAM or storage. The memory 506 can store temporary variables or other intermediate information during execution of instructions to be executed by processor 504. The communication interface 518 may enable the computer system 500 to communicate with one or more networks through use of a network such as the Internet.

In one example, the memory 506 stores workflow instructions for implementing a workflow system such as described with an example of FIG. 1. In addition to workflow instructions 511, the memory 506 can store a profile 513 for a user. The profile 513 can be based on input 509 communicated from the user. The processor 504 executes the workflow instructions 511 in order to perform workflow action 515, using the profile 513. The workflow actions 515 can correspond to operations implemented through the network interface 518, such as accessing network services and communicating data items.

Computer system 500 can include display 512, such as an LCD monitor, for displaying information to a user. The input device 414 can be coupled to computer system 500 for communicating information and command selections to processor 504. The input device 514 can correspond to, for example, a touch-screen or touch sensitive sensor, a keyboard or a selection mechanism (e.g., mouse). The user can enter input 509 for creating the workflow profile 513 using the input device 514. In variations, the input device 514 can correspond to a voice input mechanism that enables the user to operate menus and other interfaces (e.g., see FIG. 4A through FIG. 4D) in establishing actions, processes and parameters for such actions/processes.

Although illustrative embodiments have been described in detail herein with reference to the accompanying drawings, variations to specific embodiments and details are encompassed by this disclosure. It is intended that the scope of embodiments described herein be defined by claims and their equivalents. Furthermore, it is contemplated that a particular feature described, either individually or as part of an embodiment, can be combined with other individually described features, or parts of other embodiments. Thus, absence of describing combinations should not preclude the inventor(s) from claiming rights to such combinations.

What is claimed is:

1. A method for implementing a workflow on data items, the method being implemented by one or more processors and comprising:
establishing a workflow container for a user, the workflow container being associated with a profile, the profile specifying a set of actions;
receiving a set of data items in the workflow container; and
implementing multiple actions on the set of data items, based on the profile;
wherein implementing multiple actions includes performing, for at least a given data item in the set of data items, a first set of actions in parallel with a second set of actions, the first set of actions communicating the first data item to at least a first destination, and the second set of actions communicating the given data item to at least a second destination.

2. The method of claim 1, wherein the profile identifies (i) one or more destinations, and (ii) one or more actions that are performed to communicate one or more data items identified in the workflow container to the one or more destinations.

3. The method of claim 1, wherein the profile identifies a set of rules, the set of rules controlling a timing or condition for when one or more actions specified by the profile are performed.

4. The method of claim 1, wherein the profile identifies a schedule for performing one or more of the actions specified by the profile.

5. The method of claim 1, wherein performing at least the first set of actions or the second set of actions includes sequencing individual operations that are included in either the first set of actions or in the second set of actions based on input from the user that is recorded as part of the profile.

6. The method of claim 1, wherein implementing multiple actions on the set of data items includes performing one or more actions based on a type of the data item.

7. The method of claim 1, wherein implementing multiple operations on the set of data items includes selecting a destination for one or more items in the set of data items, the destination being predetermined from the profile.

8. The method of claim 1, wherein establishing the workflow container includes establishing a local folder on a user machine.

9. The method of claim 1, wherein establishing the workflow container includes establishing a remote folder as part of a network service.

10. A computer system for implementing a workflow on data items, the computer system comprising:
a memory that stores a set of instructions;
one or more processors that use instructions from memory to:
establish a workflow container for a user, the workflow container being associated with a profile, the profile identifying a set of actions that are specified by the user, and one or more schedules for performing one or more actions in the set of actions;
receive a set of data items in the workflow container;
performing multiple actions from the set of actions on individual data item in the set of data items;
wherein one or more of the multiple actions are performed in accordance with the schedule.

11. The computer system of claim 10, wherein the profile identifies (i) one or more destinations, and (ii) one or more actions that are performed to communicate a data item identified in the workflow container to the one or more destinations.

12. The computer system of claim 10, wherein the profile identifies a set of rules, the set of rules controlling a timing or condition for when one or more actions of the profile are performed.

13. The computer system of claim 10, wherein the profile identifies a schedule for performing one or more of the actions of the profile.

14. The computer system of claim 10, wherein implementing multiple operations on the set of data items includes selecting a destination for one or more items in the set of data items based on a type of the one or more data items.

15. A computer-readable medium that stores instructions for implementing a workflow on data items, the computer-readable medium including instructions, that when executed by one or more processors, cause the one or more processors to perform operations comprising:
establish a workflow container for a user, the workflow container being associated with a profile, the profile specifying a set of actions;
receive a set of data items in the workflow container; and
implement multiple actions on the set of data items, based on the profile;
wherein the multiple actions are implemented by performing, for at least a given data item in the set of data items, a first set of actions in parallel with a second set of actions, the first set of actions communicating the given data item to at least a first destination, and the second set of actions communicating the given data item to at least a second destination.
